(19) United States
(12) Patent Application Publication
(10) Pub. No.: US 2007/0240465 A1
(43) Pub. Date: Oct. 18, 2007

(54) Slim profile mortise lock assembly

(75) Inventors: Brian W. Clifford, Saint John, IN (US); James R. Stremplewski, Frankfurt, IL (US); Matthew R. JaBaay, Dyer, IN (US)

Correspondence Address: GREER, BURNS & CRAIN, 300 S WACKER DR, 25TH FLOOR, CHICAGO, IL, 60606, US

(73) Assignee: Doralco, Inc.

(21) Appl. No.: 11/405,899

(22) Filed: Apr. 18, 2006

(51) Int. Cl. E05B 9/08

(52) U.S. Cl. 70/370

(57) ABSTRACT

A lock assembly including an exterior with a lock housing block formed on its inner side and an interior member with an inner side includes a recessed portion configured to receive the lock housing block of the exterior member. The assembly further includes a first aperture that extends completely through the exterior member, a second aperture that extends completely through the interior member, a deadbolt aperture that extends completely through the lock housing block, and a deadbolt seated within the deadbolt aperture. When the interior and exterior members are aligned such that the lock housing block is seated within the recessed portion of the interior member, the first and second aperture are aligned with each other to define a cylinder aperture that extends completely through both the exterior member and the interior member. Finally, there is at least one cylinder seated within said cylinder aperture.

The present invention relates to a lock assembly, and more specifically to a mortise lock assembly with a slim profile that can be used, for example, with a glass panel door. In the preferred embodiment, the exterior and interior housing members of the lock assembly also serve as the mounting plates, thereby reducing the profile (or thickness) of the lock assembly so that the lock assembly only protrudes a minimal distance from the inside and outside surfaces of the door panel. Such a configuration reduces the visual impact of the lock assembly, which is in keeping with minimalist trends in modern architecture. One of the advantages of the present invention is that although the thickness of the lock assembly is small, the configuration of the exterior and interior members allows for a deadbolt of substantial size. In fact, in one preferred embodiment, the diameter of the deadbolt is essentially the same as the thickness of the door panel.

More specifically, the present invention relates to a lock assembly that preferably includes an exterior member with an outer side and an inner side opposite to the outer side and a lock housing block formed on the inner side, a first aperture that extends completely through the exterior member, and a deadbolt aperture that extends completely through the lock housing block. The deadbolt aperture has a longitudinal axis that preferably extends in a direction generally transverse to a center axis of the first aperture, and there is a deadbolt seated within the deadbolt aperture. The lock assembly also preferably includes an interior member with an outer side and an inner side opposite to the outer side, where the inner side includes a recessed portion configured to receive the lock housing block of the exterior member, and a second aperture that extends completely through the interior member. When the interior member and the exterior member are aligned such that the lock housing block of the exterior member is seated within the recessed portion of the interior member, the first aperture and the second aperture are aligned with each other to define a cylinder aperture that extends completely through both the exterior member and the interior member. Finally, the lock assembly preferably includes at least one cylinder seated within the cylinder aperture.

### BRIEF DESCRIPTION OF THE DRAWINGS

Preferred embodiments of the present invention are described herein with reference to the drawings wherein:

FIG. 1 is a perspective view of a preferred embodiment of the present lock assembly, viewed toward the outer side of the interior member, shown without trim plates;

FIG. 2 is an exploded perspective view of the lock assembly of FIG. 1, shown with the interior member removed to provide a better view of the lock housing block;

FIG. 3 is a perspective view of the deadbolt of the lock assembly of FIG. 1;

FIG. 4 is a perspective view of the inner side of the exterior member of the lock assembly of FIG. 1, shown with the deadbolt assembly in a locked position, with the cylinder members removed;

FIG. 5 is a perspective view of the inner side of the interior member of the lock assembly of FIG. 1;

FIG. 6 is a partially exploded side cross-section of the lock assembly of FIG. 1 shown attached to a glass panel; and

FIG. 7 is a perspective view of the deadbolt strike and box of the lock assembly of FIG. 1, shown attached to a glass panel.

### DETAILED DESCRIPTION OF THE INVENTION

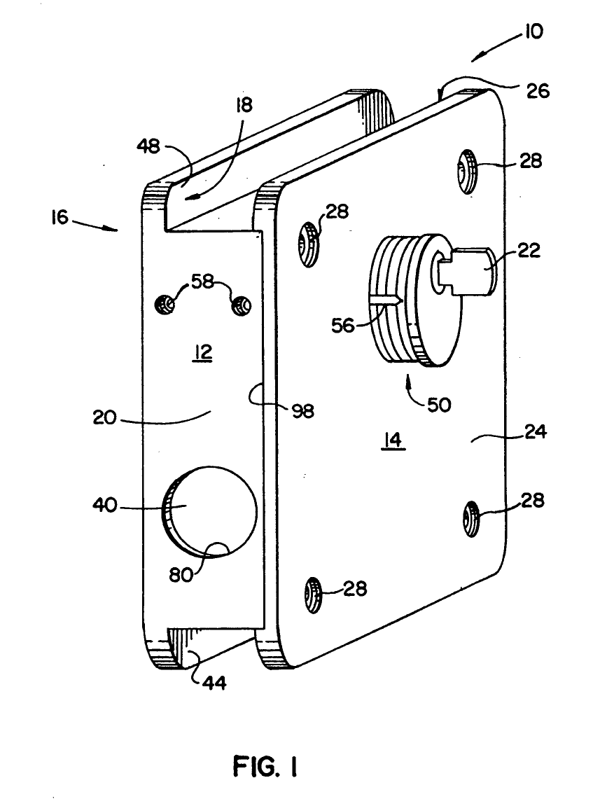

Referring now to the drawings, a preferred embodiment of the present lock assembly is shown in FIGS. 1-7, with FIG. 1 showing the lock assembly 10 as viewed from an interior side. Lock assembly 10 includes two main housing components—an exterior member 12 and an interior member 14, which are both preferably made of aluminum or other metal. The exterior member 12 is the housing member that faces the outside of the building (or outside of the area being locked, such as an office), and it includes provisions for allowing the lock assembly to be locked and unlocked by a key or other securing means (such as a number keypad for a manual or electronic lock). The exterior member 12 includes an outer side 16, an inner side 18, and a lock housing block 20 on inner side 18. As will be explained more fully below, the lock housing block 20 includes arrangements for seating most of the components of the lock assembly.

The interior member 14 is the housing member that faces the interior of the building (or within the area being locked, such as within an office), and it includes an opening for receiving an inside lock cylinder 50 operated preferably by a thumbturn 22. FIG. 1 shows inside cylinder 50 partly unscrewed from the opening in interior member 14, whereby the exposed threads will be covered by a trim plate and trim ring, neither of which are shown. The interior member includes an outer side 24 (that faces away from the lock assembly) and an inner side 26 (that faces toward the remainder of the lock assembly). The interior member 14 also preferably includes a plurality of holes 28 for receiving a plurality of fasteners to affix the interior member 14 to the exterior member 12 (which includes a plurality of corresponding threaded holes). Preferably, the holes 28 are countersunk such that the fasteners, such as flat head machine screws, will be flush with the surface of the outer side 24 of the interior member 14.

Although not shown in the drawings, the lock assembly preferably includes the previously mentioned trim pieces, as known in the art. For example, inside and outside trim plates may be affixed to side 16 and 24 by any known means, such as clips, screws or double-faced adhesive tape. Additionally, trim rings (not shown) and hardened steel insert rings (not shown) may also be provided around both cylinders.

It should be noted that in the embodiments shown in the figures, the lock block- housing 20 is integrally formed as part of the exterior member 12, which is considered to provide the most secure lock arrangement. However, it is also contemplated that the lock housing block 20 could be integrally formed as part of the interior member 14, or that the lock housing block could be a separate component that is sandwiched between two plate-like members (an interior member and an exterior member), each of which may or may not include a recess configured to receive the lock block plate.

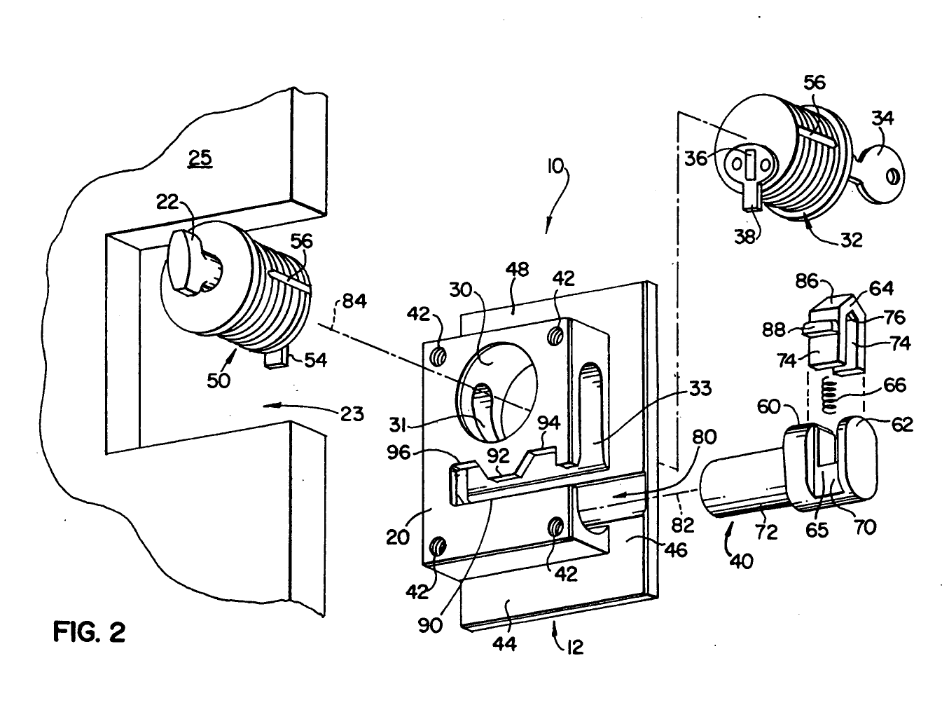

Turning now to FIG. 2, there is shown an exploded view of lock assembly 10, which view lacks interior member 14 so that the features of exterior member 12 can be more easily seen. In the preferred embodiment, the lock housing block 20 of exterior member 12 is generally rectangular, and the block is sized and configured to be received within a mortised recess 23 of a door 25. Door 25 is preferably a glass panel, although panels of materials other than glass are also contemplated as being within the scope of the invention. The asymmetric position of lock housing block 20 defines three flange portions 44, 46 and 48 on exterior member 12, which flange portions are seated on the exterior of panel 25 when lock housing block 20 is seated within mortised recess 23. Thus, exterior member serves as both a portion of the lock assembly and as one of the mounting plates for mounting the lock assembly to the panel 25.

The lock housing block 20 of exterior member 12 includes a threaded aperture 30 that is configured to receive an outside cylinder 32, which is externally threaded so that it can be seated within the internal threads of aperture 30. The outside cylinder 32 is preferably configured to be locked/unlocked by a key 34. When the key 34 is inserted and rotated, the associated tailpiece 36 also rotates, in a known manner, thereby rotating attached cam 38. As explained more fully below, cam 38 is used to slide deadbolt 40 into a locked or unlocked position. The lock housing block 20 also includes a plurality of threaded screw holes 42, which correspond with the screw holes 28 (which are not threaded) of the interior member 14, so that the interior and exterior members can be attached together by a plurality of fasteners, e.g., flat head machine screws (not shown).

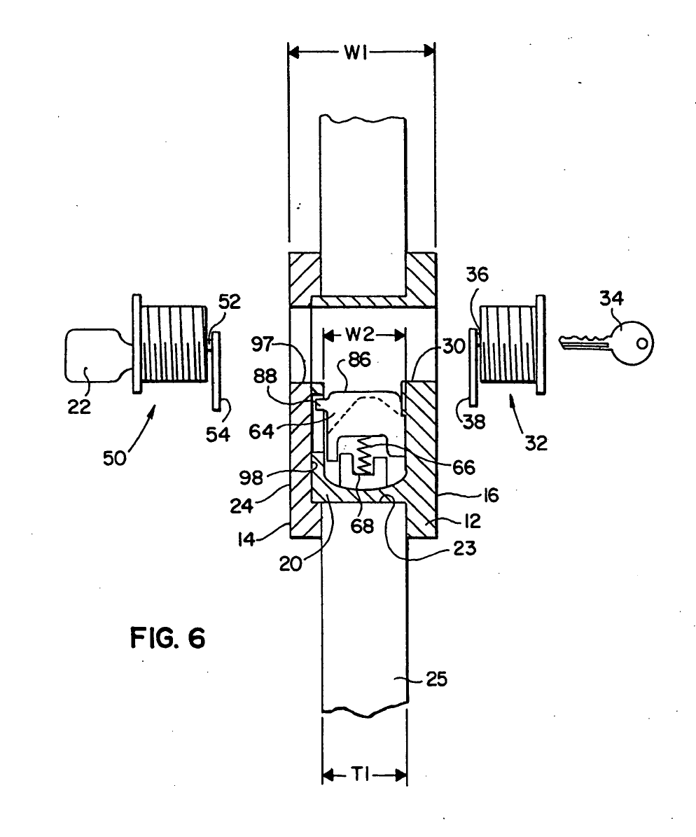

The present lock assembly 10 also preferably includes an inside cylinder 50, which is also externally threaded and includes the thumbturn 22, mentioned above. When the thumbturn 22 is rotated, the associated tailpiece 52 (FIG. 6) is rotated in a known manner, thereby rotating cam 54 (which is generally of the same configuration as cam 38). Both the inside cylinder 50 and the outside cylinder 32 can be any known type of cylinder. Preferably, each of the cylinders 32 and 50 includes at least one notched portion 56 (FIG. 2) that is configured to provide a seating surface for one of the sets screws 58 (FIG. 1) that are used to prevent the cylinders from rotating within aperture 30. As can be seen in FIG. 1, the setscrews 58 are inserted within threaded holes located on one of the sides of the lock housing block 20.

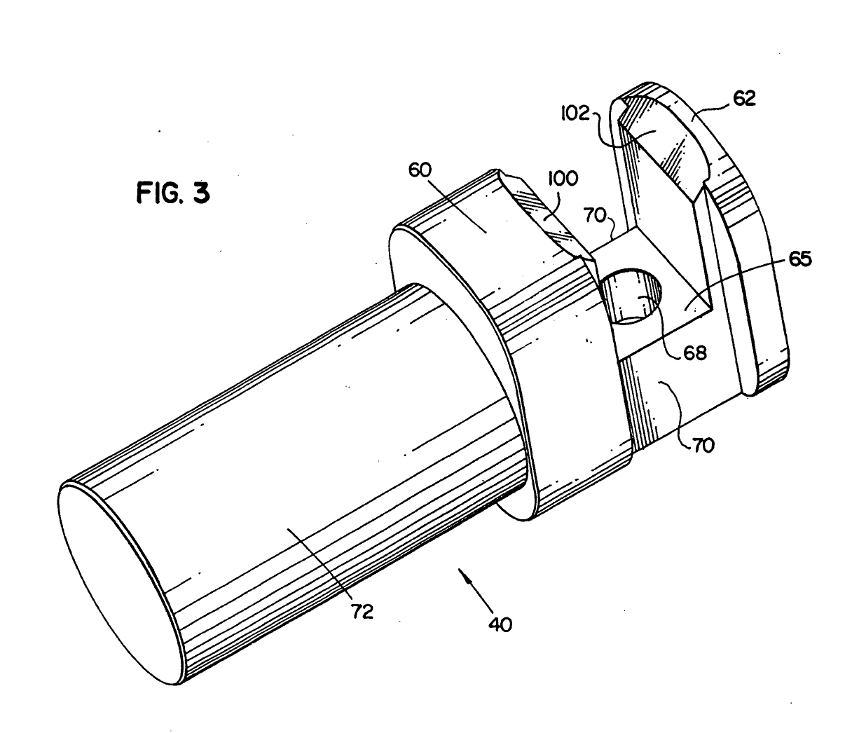

Deadbolt 40, which is also shown enlarged in FIG. 3, includes two shoulders 60 and 62 formed near one end thereof. Between these shoulders 60, 62 is formed an area 65 for seating a cap member 64 (FIG. 2), which is biased by spring 66. As can be seen in FIG. 3, this seating area 65 preferably includes a spring aperture 68, which is preferably a blind hole of a diameter slightly larger than that of spring 66 so that the spring 66 can be seated within aperture 68 to bias the cap member 64 upwardly (i.e., in a direction generally toward the aperture 30). Preferably, the sides 70 of seating area 65 are of a reduced width (when compared with the diameter of the cylindrical portion 72 of deadbolt 40) so that the legs 74 (FIG. 2) of the spring-biased cap member 64 can easily straddle the seating area 65, but with the cap member 64 can still be of a width equal to or less than the diameter of cylindrical portion 72 so that the assembled cap member/deadbolt assembly fits within deadbolt aperture 80. If desired, the upper inner surface 76 of the cap member 64 may include a blind aperture or a projection for receiving the upper end of spring 66, but such aperture or projection is not necessary for maintaining the spring in position.

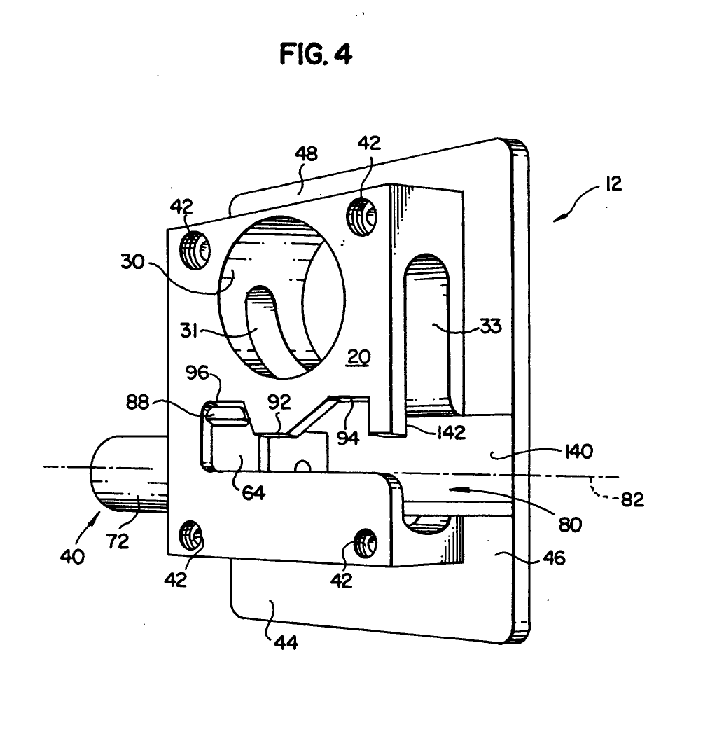

The deadbolt 40 is configured to slide within deadbolt aperture 80, which is located within the lock housing block 20. The deadbolt aperture 80 extends completely through the lock housing block 20, and has a longitudinal axis 82 (see also FIG. 4) that is generally transverse to the center axis 84 of aperture 30. Additionally, the upper portion of deadbolt aperture 80 is in communication with the lower portion of aperture 30 so that cams 38 and 54 can make contact with the generally horizontal upper surface 86 of spring-biased cap member 64.

The spring-biased cap member 64 also includes a tab 88 that extends from one of its sides. The tab 88 is designed to extend through a cutout portion 90 formed in the side of deadbolt aperture 80. The upper surface 92 of the cutout portion 90 includes two notched seating areas 94 and 96, as shown in both FIGS. 2 and 4. These notched seating areas 94 and 96 are configured to seat the tab 88 of the spring-biased cap member 64 to maintain the deadbolt 40 in either the locked position (area 96) or the unlocked position (area 94), as will be explained more fully below.

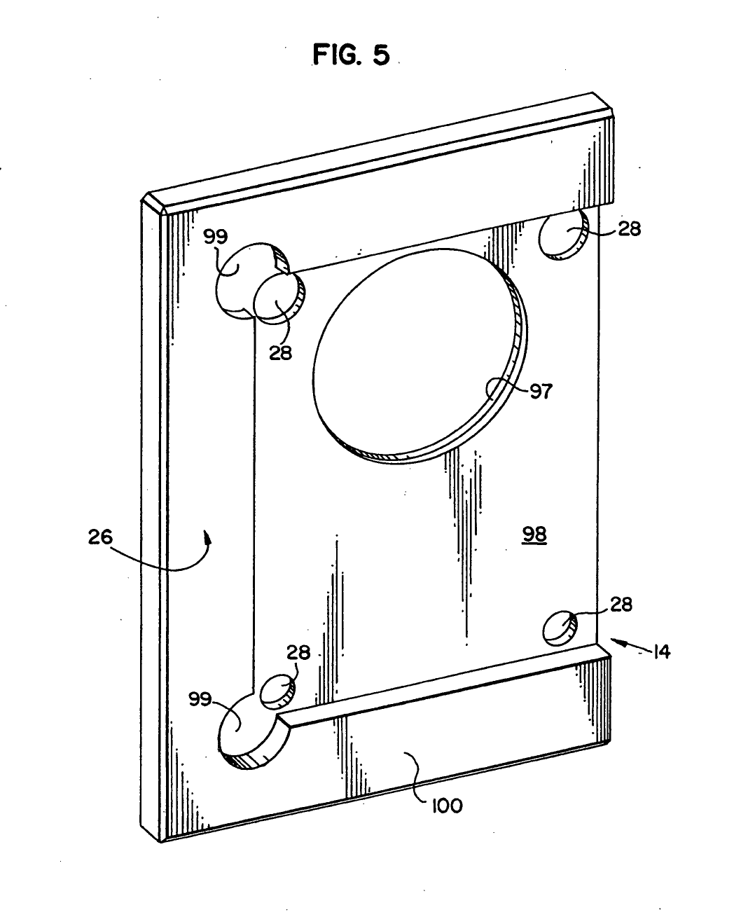

Turning now to FIG. 5, the interior member 14 of the lock assembly 10 will be described. Interior member 14 is a generally plate-like component that is preferably formed of aluminum, or other suitable metal, and it includes a cylinder aperture 97, which is preferably not threaded, but that is configured to align with cylinder aperture 30 (FIG. 2) of the exterior member 12. When interior member 14 and exterior member 12 are assembled together, cylinder apertures 30 and 97 align to define one long aperture that extends completely through the lock assembly 10.

As can be seen in FIG. 5, interior member 14 preferably includes two semi-circular cutouts 99, located near two of the screw holes 28 near the corners of recessed portion 98, cutouts 99 are provided to compensate for any discrepancies formed in the corners of mortised recess 23 (FIG. 2) when the recess is created.

One of the main features of interior member 14 is recessed portion 98, which is recessed into the inner side 26. The recessed portion 98 is configured of a size and shape to receive the lock housing block 20 of the exterior member 16 so that members 12 and 14 can be assembled together to form a complete assembly, such as that shown in FIG. 1. Recessed portion 98 interlocks with block 20 to prevent any rotation or miss-alignment of interior member 14 with outer member 12. The non-recessed portion 100, which surrounds the recessed portion 98 on three sides, is configured to be seated against the interior surface of panel 25 (FIGS. 2 and 4), and accordingly performs the purpose of a mounting plate. If desired, a layer of rubber or other elastomeric material may be attached to the non-recessed portion 100 to reduce rattling and to provide a tighter fit against the inside surface of the panel 25. A similar layer of rubber or other elastomeric material may also be provided on flanges 44, 46 and 48 of exterior member 12 for the same purpose with respect to interface between the outside surface of the panel 25 and the exterior member 25.

The recessed portion 98 of interior member 14, in combination with the lock housing block 20, allows the lock assembly to be of a thin profile (in the thickness direction) but still of sufficient strength. For example, since the recessed portion attaches to the relatively thicker, and stronger, lock housing block 20, this portion of the assembly can derive much of its strength from the lock housing block, and only a relatively thin recessed portion is needed. Such a configuration results in a thinner lock assembly when compared with a lock assembly without a recessed portion, or to a lock assembly in which the lock housing parts are not also configured to serve as the mounting plates. Such a configuration also permits the deadbolt to be of a width, represented by W2 in FIG. 6, that is approximately equal to the thickness, T1, of the glass panel 25. In one embodiment configured for use with a ½ inch thick glass panel (where T1=0.5 inches), the deadbolt width (W2) is approximately 0.625 inches. Preferably, a ratio, W2/T1, is approximately between the range of 1.00 to 1.75.

The thin profile of the present invention, when compared to prior art lock assemblies, should be evident from some of the following ratios, which will be described with reference to FIG. 6. In the preferred embodiment, a first ratio of W1/W2 is between the preferably range of 1.25 to 1.75, where “W1” is a width taken between said outer side of said exterior member and said outer side of said interior member, when said interior member and said exterior member are attached together, and “W2” is a width of said deadbolt taken along the same direction as W1. For the sake of illustration only, W1 may be approximately 0.875 inches and W2 may be approximately 0.625 inches.

In the preferred embodiment, a second ratio of W1/T1 is preferably within the range of 1.5 to 2.0, where, as shown in FIG. 6, “W1” is, once again, a width taken between said outer side of said exterior member and said outer side of said interior member, when said interior member and said exterior member are attached together, and “T1” is a thickness of said glass panel taken along the same direction as W1. For the sake of illustration only, W1 may be approximately 0.875 inches and Ti may be approximately 0.5 inches.

In addition to having a thin profile, the other dimensions of the present lock assembly are also preferably relatively small. By way of example only, the height of the interior and exterior plates may be approximately 3.5 inches, and their widths may be approximately 2.5 inches. The cylinder diameters may be approximately 1.25 inches each. Such relatively small dimensions minimize the visual impact of the lock, while maximizing the visual impact of the glass door.

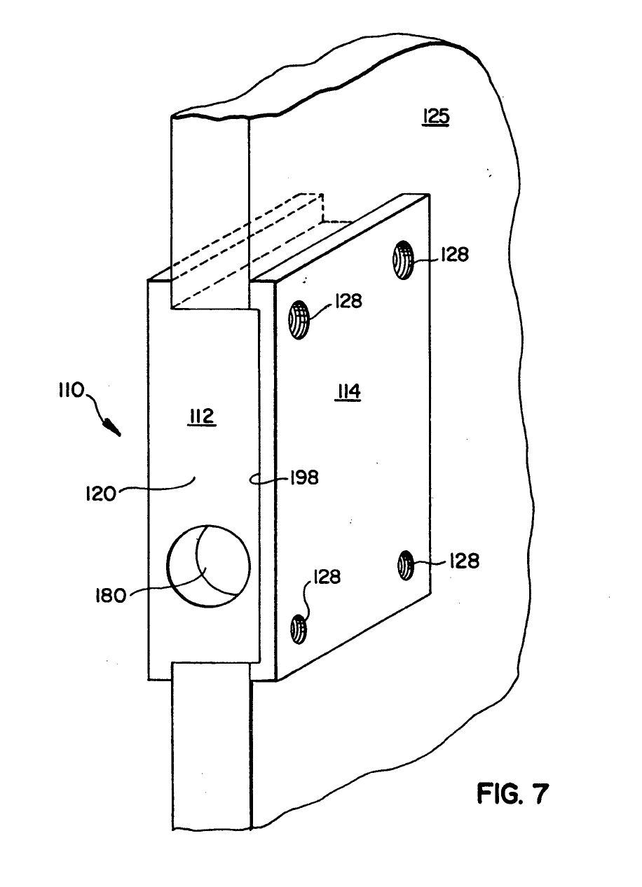

Turning now to FIG. 7, the strike assembly 110, or deadbolt strike, of the present lock assembly will be described. The strike assembly 110 is the portion of the lock assembly that is configured to be mounted upon a stationary panel 125 that is adjacent to the door panel 25 (FIG. 2). In the preferred embodiment, panel 125, like door panel 25, is made of glass. However, other materials are also acceptable. Additionally, instead of being a stationary, fixed panel, panel 125 may also be comprised of another door, such that a double door configuration is formed.

Strike assembly 110 is composed of two parts—an exterior member 112 and an interior member 114. Interior member 114 of the strike assembly is basically a simplified version of interior member 14, except that is does not include a cylinder aperture. However, interior member 114 does include countersunk screw holes 128 (similar to screw holes 28 of FIG. 1) and a recessed portion 198 (similar to recessed portion 98 of FIG. 5). Likewise, exterior member 112 of the strike assembly is basically a simplified version of exterior member 12, except that it lacks the cylinder aperture. However, exterior member 112 does include a block 120, which is similar to lock housing block 20 of FIG. 2, except that block 20 includes a simplified deadbolt aperture 180, or deadbolt box, which is merely a cylindrical bore that is configured to receive the cylindrical portion 72 of deadbolt 40 (FIGS. 2 and 3). The strike assembly is configured to be seated in a mortised recess, similar to mortised recess 23 of FIG. 2, and the surfaces of the strike assembly that contact the front and rear surfaces of the panel 125, adjacent the recess, may include a rubber or elastomeric layer to prevent rattling and to provide a tighter fit for the strike assembly.

Turning now primarily to FIGS. 2, 4 and 6, the operation of the present lock assembly 20 will be described. When the lock assembly 10 is completely assembled, cam 54 of inside cylinder 50 and cam 38 of outside cylinder will nearly contact each other within combined aperture 30/97. However, care should be taken to ensure that there is at least some space between cams 54 and 38 so that both cams can rotate freely.

When either cam 54 or cam 38 is rotated to the downwardly pointing positions shown in FIGS. 2 and 6 (by turning thumbturn 22 or by turning key 34), the downwardly pointing cam makes contact with the horizontal upper surface 86 of cap member 64. The cam (54 or 38) then presses cap member 64 in the downward direction, against the upward force of spring 66. Continued rotation of either cam (54 or 38) causes the rotating cam to engage one of the shoulders 60 or 62 of the deadbolt 40, thereby causing deadbolt 40 to slide within deadbolt aperture 80. To facilitate such engagement (and disengagement) between one of the cams and one of the shoulders, each of the shoulders 60,62 preferably includes a chamfer, 100 or 102, on its inside surface, as best shown in FIG. 3. As shown in FIG. 4, the lock housing block 20 preferably includes side spaces to permit full rotation of the cams 38 and 54, such as recess 31 and side slot 33.

After the thumbturn 22 or the key 34 has been completely rotated to a fully locked or fully unlocked position, the cam (54 or 38) will be rotated out of engagement with the spring-biased cap member 64, allowing the spring 66 to push the cap member 64 upwardly, so that tab 88 engages one of the notched areas (94 or 96) of the cutout portion 90, thereby maintaining the deadbolt 40 in either the locked or the unlocked position.

For example, FIG. 4 shows deadbolt 40 in the locked position (wherein cylindrical portion 72 would be seated within deadbolt aperture 180 of the strike assembly 110 of FIG. 7). As can be seen in FIG. 4, tab 88 of spring-biased cap member 64 is seated within notched area 96, thereby maintaining deadbolt 40 in the locked position. To slide the deadbolt 40 to the unlocked position, out of engagement with deadbolt aperture 180 (FIG. 7), which is to the left as shown in FIG. 4, either key 34 or thumbturn 22 (FIG. 6) needs to be rotated into the unlocked position. Such rotation of either key 34 or thumbturn 22 causes the associated cam (38 or 54) to rotate into contact with cap member 64, to press the cap member downwardly against the upward force of spring 66. Once tab 88 is pushed downwardly enough to clear the area of upper surface 92 of cutout portion 90 between notched areas 94 and 96, the deadbolt 40 can be slid to toward the right, and into the tab 88 can seat into notched area 94, which is the unlocked position, where the cylindrical portion 72 is out of engagement with deadbolt aperture 180 (FIG. 7).

Preferably, the deadbolt 40 includes means for preventing it from rotating within the deadbolt aperture 80. For example, FIG. 2 shows how the end of the deadbolt near the shoulder 62 is formed of a generally oval shape, with straight side surfaces. This shape corresponds to the side surfaces 140, 142 of the deadbolt aperture 80 of FIG. 2. If desired, surface 140 may be recessed within exterior member 12 to reduce the overall thickness of the assembly 10 even further. It is contemplated that other non-circular shapes, other than the straight-sided oval shape shown, may also be used to prevent the deadbolt from rotating with the deadbolt aperture.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A lock assembly comprising:
an exterior member including an outer side and an inner side opposite to said outer side, and a first aperture that extends completely through said exterior member;
a lock housing block on said inner side of said exterior member having a deadbolt aperture that extends completely through said lock housing block, said deadbolt aperture having a longitudinal axis that extends in a direction generally transverse to an axis of said first aperture;
a deadbolt slidably received within said deadbolt aperture;
an interior member including an outer side and an inner side opposite to said outer side, said inner side having a recessed portion configured to receive said lock housing block of said exterior member and a second aperture that extends completely through said interior member;
wherein when said interior member and said exterior member are aligned such that said lock housing block is seated within said recessed portion of said interior member, said first aperture and said second aperture define a cylinder aperture that extends completely through both said exterior member and said interior member;
at least one cylinder seated within said cylinder aperture; and
at least one fastener engaging said interior member and exterior member for fastening said interior and exterior members together with said lock housing block sandwiched therebetween.

2. The lock assembly of claim 1 wherein said lock housing block is integrally formed with said exterior member.

3. The lock assembly as defined in claim 1, wherein:
said exterior member further includes at least one flange portion adjacent to said lock housing block.

4. The lock assembly as defined in claim 1, wherein:
said lock housing block is generally rectangular and is defined by first and second side edges, an upper edge and a lower edge; and
said exterior member further includes a side flange portion adjacent said first side edge of said lock housing block, an upper flange portion adjacent said upper edge of said lock housing block, a lower flange portion adjacent said lower edge of said lock housing block; and
wherein said second side edge of said lock housing block is substantially flush with a corresponding edge of said interior member.

5. The lock assembly as defined in claim 1, wherein a ratio W1/W2 is between the range of 1.25 to 1.75, where “W1” is a width between said outer side of said exterior member and said outer side of said interior member, when said interior member and said exterior member are attached together, and “W2” is a width of said deadbolt taken along the same direction as W1.

6. The lock assembly as defined in claim 1, wherein said at least one cylinder comprises two cylinders, wherein said two cylinders consist of an outside cylinder positioned within a first axial portion of said cylinder aperture, and an inside cylinder positioned within a second axial portion of said cylinder aperture.

7. The lock assembly as defined in claim 6, wherein:
said outside cylinder is configured to be operated by a key; and
said inside cylinder is configured to be operated by a thumbturn.

8. The lock assembly as defined in claim 6, wherein:
said outside cylinder includes a first tailpiece extending inwardly, and said first tailpiece includes a first cam configured to rotate therewith; and
said inside cylinder includes a second tailpiece extending inwardly, and said second tailpiece includes a second cam configured to rotate therewith.

9. The lock assembly as defined in claim 1, wherein:
said at least one cylinder includes a tailpiece extending inwardly, and said tailpiece includes a cam configured to rotate therewith;
said deadbolt includes a spring-biased cap member positioned near one end of said deadbolt, said spring-biased cap member is biased by a spring force directed generally in a direction toward said cylinder aperture and is configured to be acted upon by said cam in a direction opposite of the direction of spring force, and said spring-biased cap member includes a tab extending from one side thereof; and
said lock having block further including a cutout portion adjacent said deadbolt aperture configured for receiving said tab of said spring-biased cap member.

10. The lock assembly as defined in claim 9, wherein said cutout portion includes two notched seating areas for seating said tab of said spring-biased cap member in an locked and unlocked positions, respectively.

11. The lock assembly as defined in claim 9, wherein said spring-biased cap member is seated between two shoulders formed near said one end of said deadbolt.

12. The lock assembly as defined in claim 1, wherein:
said at least one cylinder comprises two cylinders, wherein said two cylinders consist of an outside cylinder positioned within a first axial portion of said cylinder aperture, and an inside cylinder positioned within -a second axial portion of said cylinder aperture;
a first tailpiece extending inwardly from said outside cylinder, said first tailpiece having a first cam configured to rotate therewith;
a second tailpiece extending inwardly from said inside cylinder, and said second tailpiece having a second cam configured to rotate therewith;
a spring-biased cap member positioned between two shoulders located near one end of said deadbolt, said spring-biased cap member being biased by a spring force in a direction generally toward said cylinder aperture, and being configured to be acted upon by either said first cam or said second cam in a direction opposite of the direction of spring force, said spring-biased cap member having a tab extending from one side thereof; and
said lock housing block having a cutout portion adjacent said deadbolt aperture and configured for receiving said tab of said spring-biased cap member, wherein said cutout portion of said deadbolt aperture includes two notched seating areas for seating said tab of said spring-biased cap member.

13. A glass door locking system comprising:
a glass door including an interior surface, an exterior surface, and at least one side edge, wherein said side edge includes a mortised recess therein;
a lock assembly mounted within said mortised recess, said lock assembly including:
an exterior member including an outer side and an inner side opposite to said outer side, said exterior member further including a lock housing block on said inner side, a first aperture that extends completely through said exterior member, a deadbolt aperture that extends completely through said lock housing block, said deadbolt aperture having a longitudinal axis that extends in a direction generally transverse to an axis of said first aperture;
a deadbolt seated within said deadbolt aperture;
an interior member including an outer side and an inner side opposite to said outer side, wherein said inner side includes a recessed portion configured to receive said lock housing block of said exterior member, a second aperture that extends completely through said interior member;
wherein when said interior member and said exterior member are aligned such that said lock housing block of said exterior member is seated within said recessed portion of said interior member, said first aperture and said second aperture are aligned with each other to define a cylinder aperture that extends completely through both said exterior member and said interior member;
at least one cylinder seated within said cylinder aperture; and
at least one fastener for fastening said interior member to said interior member and clamping said glass door between said interior and interior windows.

14. The glass door locking system as defined in claim 13, further comprising:
a glass panel adjacent said glass door;
a deadbolt strike mounted on an edge of said glass panel; and
a box within said deadbolt strike for receiving said deadbolt.

15. The lock assembly as defined in claim 13, wherein said deadbolt has a width, and said glass panel has a thickness taken along the same direction of said deadbolt width, and further wherein said deadbolt width is approximately equal to said thickness of said glass panel.

16. The glass door locking system as defined in claim 13, wherein a ratio W1/T1 is between the range of 1.5 to 2.0, where “W1” is a width taken between said outer side of said exterior member and said outer side of said interior member, when said interior member and said exterior member are attached together, and “T1” is a thickness of said glass panel taken along the same direction as W1.

17. The glass door locking system as defined in claim 13, wherein:
said at least one cylinder comprises two cylinders, wherein said two cylinders consist of an outside cylinder positioned within a first axial portion of said -cylinder aperture, and an inside cylinder positioned within a second axial portion of said cylinder aperture;
a first tailpiece extending inwardly from said outside cylinder, and a first cam on said first tailpiece configured to rotate therewith; and
a second tailpiece extending inwardly from said inside cylinder, and a second cam on said second tailpiece configured to rotate therewith.

18. The glass door locking system as defined in claim 17, wherein:
a spring-biased cap member carried by said deadbolt, said spring-biased cap member being biased in a direction generally toward said cylinder aperture, and configured to be acted upon by either said first cam or said second cam in a direction opposite of the direction of spring force, said spring-biased cap member having a tab extending from one side thereof; and
said lock block having a cutout portion adjacent said deadbolt aperture configured for receiving said tab of said spring-biased cap member, wherein said cutout portion includes two notched seating areas for seating said tab of said spring-biased cap member.

19. The glass door locking system as defined in claim 18, wherein said spring-biased cap member is seated between two shoulders formed near said one end of said deadbolt.

20. A lock assembly comprising:
an exterior member including an outer side and an inner side opposite to said outer side, and a first aperture that extends completely through said exterior member;
a generally rectangular lock housing block integrally formed on said inner side of said exterior member having a threaded deadbolt aperture that extends completely through said lock housing block, said deadbolt aperture having a longitudinal axis that extends in a direction generally transverse to an axis of said first aperture;
a deadbolt slidably received within said deadbolt aperture, at least a portion of said deadbolt being includes at least a portion of a shape for preventing rotation of said deadbolt within said deadbolt aperture;
at least one flange portion on said exterior member located adjacent to said lock housing block;
an interior member including an outer side and an inner side opposite to said outer side, said inner side having a recessed portion configured to receive said lock housing block of said exterior member and a second aperture that extends completely through said interior member;
wherein when said interior member and said exterior member are aligned such that said lock housing block is seated within said recessed portion of said interior member, said first aperture and said second aperture define a cylinder aperture that extends completely through both said exterior member and said interior member;
an outside cylinder positioned within a first axial portion of said cylinder aperture;
an inside cylinder positioned within a second first axial portion of said cylinder aperture; and
at least one fastener engaging said interior member and exterior member for fastening said interior and exterior members together.
